(19) United States
(12) Patent Application Publication
(10) Pub. No.: US 2012/0192087 A1
(43) Pub. Date: Jul. 26, 2012

(54) METHOD AND SYSTEM FOR A VIRTUAL PLAYDATE

(75) Inventor: Tara Lemmey, San Francisco, CA (US)

(73) Assignee: Net Power and Light, Inc., San Francisco, CA (US)

(21) Appl. No.: 13/359,409

(22) Filed: Jan. 26, 2012

Related U.S. Application Data
(60) Provisional application No. 61/436,548, filed on Jan. 26, 2011.

(51) Int. Cl. G06F 3/01; G06F 15/16

(52) U.S. Cl. 715/753

(57) ABSTRACT

The present invention contemplates a variety of methods and systems for providing an interactive event experience with multi-dimensional layers embodied as a virtual playdate or family experience.

### CROSS-REFERENCE TO RELATED APPLICATIONS

This application claims the benefit of U.S. Provisional Application No. 61/436,548 entitled “METHOD AND SYSTEM FOR A VIRTUAL PLAYDATE”, filed Jan. 26, 2011, and is hereby incorporated by reference in its entirety.

### BACKGROUND OF INVENTION

### Field of Invention

The present teaching relates to interactive event experiences and more specifically, virtual playdate event experiences. Certain virtual playdates are created and initiated by a host participant, perhaps a parent, and may involve a variety of multi-dimensional layers such as video, group participation, gesture recognition, heterogeneous device use, emotions, etc.

### SUMMARY OF THE INVENTION

The present invention contemplates a variety of methods and systems for providing an interactive event experience with multi-dimensional layers embodied as a virtual playdate.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates a system architecture for composing and directing user experiences;

FIG. 2 illustrates another system architecture for composing and directing user experiences, emphasizing a variety of venues;

FIG. 3 is a block diagram of an experience agent;

FIG. 4 is a block diagram of a sentio codec;

FIGS. 5-6 illustrate example experiences with multiple composite layers;

FIG. 7 is a flow chart illustrating a method for creating and directing an interactive social event experience;

FIGS. 8-9 illustrate several example pre-event activities of one virtual playdate embodiment;

FIGS. 10-14 illustrate several example activities of another virtual playdate embodiment;

FIGS. 15-17 illustrate several example post-event activities of yet another virtual playdate experience;

FIGS. 18-27 illustrate several example activities which may occur in a virtual playdate or family experience;

FIG. 28 illustrates an embodiment of a device suitable for use by a child participating a virtual playdate;

FIG. 29 illustrates a block diagram of a system for providing distributed execution or rendering of various layers associated with a virtual playdate;

FIG. 30 is a flow chart of a method for distributed execution of a layered virtual playdate.

### DETAILED DESCRIPTION OF THE INVENTION

The following teaching describes a plurality of systems, methods, and paradigms for implementing a virtual playdate. The virtual playdate enables participants to interact with one another in a variety of different remote and/or local settings, within various virtual, physical, and combined environments. The virtual playdate has a host of advantages. In many situations, parents are reluctant to allow their children to roam freely outside of their home, even with other reliable children, unless there is known adult supervision. The virtual playdate allows parents to give their child the freedom of creating and/or participating in a social play scenario which doesn't have to involve direct parental supervision, and can expand, albeit virtually, the playdate beyond the bounds of the child's home. Likewise, this frees up the parent to attend to other tasks without interference from their children.

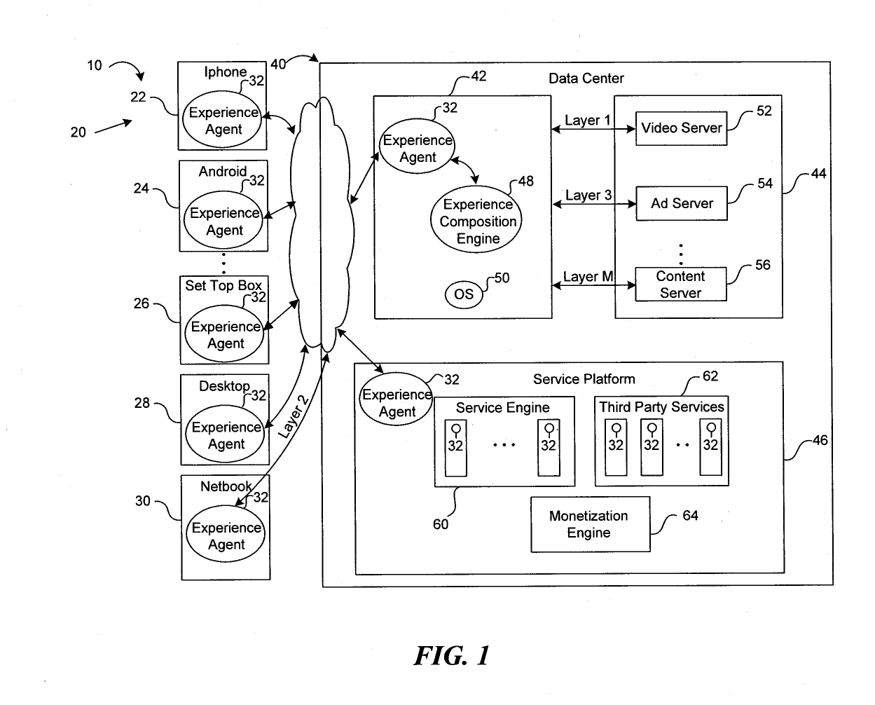

One specific platform for creating, producing and directing the virtual playdate event experience is described in some detail with reference to certain FIGS. including FIGS. 1-3. Those skilled in the art will recognize that any suitable platform within any computing environment can be utilized. One embodiment of the platform of FIGS. 1-3 provides for various processing aspects of a layered event experience to be distributed among a variety of devices.

The disclosure begins with a description of an experience platform, which is one embodiment suitable for providing a layered application or virtual playdate. Once the layer concept is described in the context of the experience platform with several examples, the present teaching provides more discussion of virtual playdates, together with additional specific playdate examples.

FIG. 1 illustrates a block diagram of a system 10. The system 10 can be viewed as an “experience platform” or system architecture for composing and directing a participant experience such as a virtual playdate. In one embodiment, the experience platform 10 is provided by a service provider to enable an experience provider to compose and direct a virtual playdate. The service provider could be a third party providing a service to any variety of users or experience providers, where the experience providers could be another independent party coordinating a virtual playdate. The service provider or the experience provider could be a specific content provider such as Disney® or Pixar®. The service provider and the experience provider could in some instances be the same entity. The experience provider could be one or more parents utilizing the experience platform to create an event for children participants, and the experience provider could even be one or more children creating their own virtual playdate.

The virtual playdate involves one or more experience participants. In some embodiments, the experience participants include a plurality of children, with at least one parent assisting or overseeing the creation of the event. Other embodiments have a representative of an entity or organization participating, so the one or more children involved could be engaged in a virtual playdate with the entity. The entity or organization could be represented by an actual person, or an avatar or such interacting with the children.

The experience provider can create a virtual playdate with a variety of suitable dimensions such as base content, live video content from an amusement park, a collaborative social drawing program, a virtual goods marketplace, etc. The virtual playdate is very well suited to provide an educational component, with interactive and adaptive features. As will be appreciated, the following description provides one paradigm for understanding the multi-dimensional experience available to the virtual playdate participants. There are many suitable ways of describing, characterizing and implementing the experience platform contemplated herein.

In general, services are defined at an API layer of the experience platform. The services provide functionality that can be used to generate “layers” that can be thought of as representing various dimensions of experience. The layers form to make features in the experience.

By way of example, the following are some of the services and/or layers that can be supported on the experience platform.

Video—is the near or substantially real-time streaming of the video portion of a video or film with near real-time display and interaction.

Video with Synchronized DVR—includes video with synchronized video recording features.

Synch Chalktalk—provides a social drawing application that can be synchronized across multiple devices.

Virtual Experiences—are next generation experiences, akin to earlier virtual goods, but with enhanced services and/or layers.

Video Ensemble—is the interaction of several separate but often related parts of video that when woven together create a more engaging and immersive experience than if experienced in isolation.

Explore Engine—is an interface component useful for exploring available content, ideally suited for the human/computer interface in a experience setting, and/or in settings with touch screens and limited i/o capability

Audio—is the near or substantially real-time streaming of the audio portion of a video, film, karaoke track, song, with near real-time sound and interaction.

Live—is the live display and/or access to a live video, film, or audio stream in near real-time that can be controlled by another experience dimension. A live display is not limited to single data stream.

Encore—is the replaying of a live video, film or audio content. This replaying can be the raw version as it was originally experienced, or some type of augmented version that has been edited, remixed, etc.

Graphics—is a display that contains graphic elements such as text, illustration, photos, freehand geometry and the attributes (size, color, location) associated with these elements. Graphics can be created and controlled using the experience input/output command dimension(s) (see below).

Input/Output Command(s)—are the ability to control the video, audio, picture, display, sound or interactions with human or device-based controls. Some examples of input/output commands include physical gestures or movements, voice/sound recognition, and keyboard or smart-phone device input(s).

Interaction—is how devices and participants interchange and respond with each other and with the content (user experience, video, graphics, audio, images, etc.) displayed in an experience. Interaction can include the defined behavior of an artifact or system and the responses provided to the user and/or player.

Game Mechanics—are rule-based system(s) that facilitate and encourage players to explore the properties of an experience space and other participants through the use of feedback mechanisms. Some services on the experience Platform that could support the game mechanics dimensions include leader boards, polling, like/dislike, featured players, star-ratings, bidding, rewarding, role-playing, problem-solving, etc.

Ensemble—is the interaction of several separate but often related parts of video, song, picture, story line, players, etc. that when woven together create a more engaging and immersive experience than if experienced in isolation.

Auto Tune—is the near real-time correction of pitch in vocal and/or instrumental performances. Auto Tune is used to disguise off-key inaccuracies and mistakes, and allows singer/players to hear back perfectly tuned vocal tracks without the need of singing in tune.

Auto Filter—is the near real-time augmentation of vocal and/or instrumental performances. Types of augmentation could include speeding up or slowing down the playback, increasing/decreasing the volume or pitch, or applying a celebrity-style filter to an audio track (like a Lady Gaga or Heavy-Metal filter).

Remix—is the near real-time creation of an alternative version of a song, track, video, image, etc. made from an original version or multiple original versions of songs, tracks, videos, images, etc.

Viewing 360°/Panning—is the near real-time viewing of the 360° horizontal movement of a streaming video feed on a fixed axis. Also the ability to for the player(s) to control and/or display alternative video or camera feeds from any point designated on this fixed axis.

Turning back to FIG. 1, the experience platform 10 for implementing a playdate includes a plurality of devices 20 and a data center 40. The devices 20 may include devices such as an iPhone 22, an android 24, a set top box 26, a desktop computer 28, and a netbook 30. The devices 20 may include network enabled children's toys. At least some of the devices 20 may be located in proximity with each other and coupled via a wireless network.

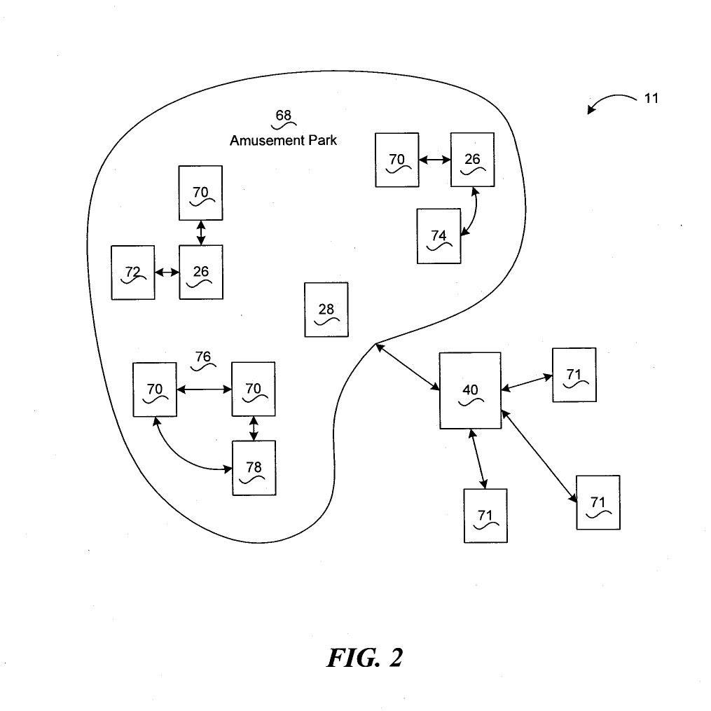

In certain embodiments, a participant utilizes multiple devices 20 to enjoy a heterogeneous experience, such as using the iPhone 22 to control operation of the other devices. For example, consider a virtual playdate involving a first child at an amusement park, and a second child at a home location. The first child may utilize her iPhone to control a variety of devices available in the amusement park--say a large display screen connected to the network, which provides a video chat connection to the second child when the first child comes in proximity to the large display screen. The two children may then engage with one another, and various other layers (content, drawing, gaming) may facilitate their play. Multiple participants may also share devices such as the display screen disposed at one location, or the devices may be distributed across various locations for different participants. This type of embodiment is described below in more detail with reference to FIG. 2.

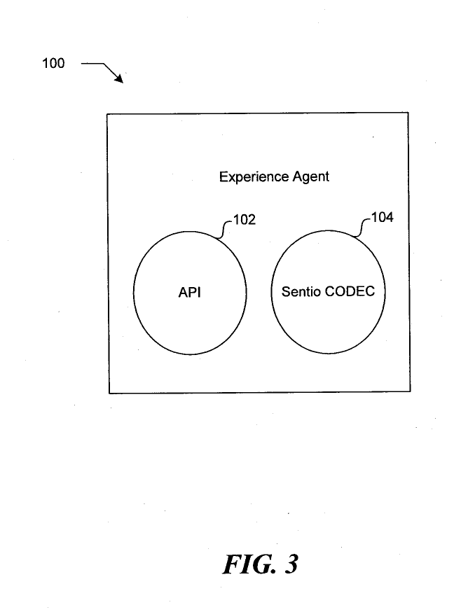

Each device 20 typically has an experience agent 32. The experience agent 32 includes a sentio codec and an API, one embodiment being described below in more detail with reference to FIG. 3. The sentio codec and the API enable the experience agent 32 to communicate with and request services of the components of the data center 40. The experience agent 32 facilitates direct interaction between other local devices. In one embodiment, the multi-dimensional aspects of the virtual playdate are facilitated through the sentio codec and API. The functionality of each particular experience agent 32 is typically tailored to the needs and capabilities of the specific device 12 on which the experience agent 32 is instantiated. In some embodiments, services implementing experience dimensions are implemented in a distributed manner across the devices 12 and the data center 40. In other embodiments, the devices 12 have a very thin experience agent 32 with little functionality beyond a minimum API and sentio codec, and the bulk of the services and thus composition and direction of the experience are implemented within the data center 40.

Data center 40 includes an experience server 42, a plurality of content servers 44, and a service platform 46. As will be appreciated, data center 40 can be hosted in a distributed manner in the “cloud,” and typically the elements of the data center 40 are coupled via a low latency network. The experience server 42, servers 44, and service platform 46 can be implemented on a single computer system, or more likely distributed across a variety of computer systems, and at various locations.

The experience server 42 includes at least one experience agent 32, an experience composition engine 48, and an operating system 50. In one embodiment, the experience composition engine 48 is defined and controlled by the experience provider to compose and direct the experience for one or more participants utilizing devices 12. Direction and composition is accomplished, in part, by merging various content layers and other elements into dimensions generated from a variety of sources such as the service provider 42, the devices 12, the content servers 44, and/or the service platform 46.

The content servers 44 may include a video server 52, an ad server 54, and a generic content server 56. Any content suitable for encoding by an experience agent can be included as an experience layer. These include well know forms such as video, audio, graphics, and text. As described in more detail earlier and below, other forms of content such as gestures, emotions, temperature, proximity, etc., are contemplated for encoding and inclusion in the experience via a sentio codec, and are suitable for creating dimensions and features of the experience.

The service platform 46 includes at least one experience agent 32, a plurality of service engines 60, third party service engines 62, and a monetization engine 64. In some embodiments, each service engine 60 or 62 has a unique, corresponding experience agent. In other embodiments, a single experience 32 can support multiple service engines 60 or 62. The service engines and the monetization engines 64 can be instantiated on one server, or can be distributed across multiple servers. The service engines 60 correspond to engines generated by the service provider and can provide services such as audio remixing, gesture recognition, calendar scheduling, profile checking, and other services referred to in the context of dimensions above, etc. Third party service engines 62 are services included in the service platform 46 by other parties. The service platform 46 may have the third-party service engines instantiated directly therein, or within the service platform 46 these may correspond to proxies which in turn make calls to servers under control of the third-parties.

Monetization of the service platform 46 can be accomplished in a variety of manners. For example, the monetization engine 64 may determine how and when to charge the experience provider for use of the services, as well as tracking for payment to third-parties for use of services from the third-party service engines 62.

FIG. 2 illustrates a block diagram of a virtual playdate system 11 incorporating a specific venue into the event experience. The specific venue could take any suitable form such as an amusement park, amusement center, sporting arena, school yard, classroom, public playground, etc. The virtual playdate system 11 includes a plurality of participants 70 each spending some time in a virtual playdate at an amusement park 68, and a plurality of participants 71 participating from home or another location remote from the amusement park 68. Each participant 70 and 71 typically has or utilizes a device 20 facilitating participation in the virtual playdate. At various locations throughout the amusement park 68, other devices are disposed for engaging in the virtual playdate.

With further reference to FIG. 2, at one location in the amusement park 68, a set-top box 26 is coupled to a large screen display 72. When a specific participant 70 comes into physical proximity to the set-top box 26, the specific participant 70 is provided content and engagement in the virtual playdate. One or more different local or remote users 70-71 can be involved in a video chat via the large screen display 72. The set-top box 26 and screen 72 could be used for other purposes (advertising, etc) when no participants are in active engagement.

A subvenue 76 dedicated to virtual playdates can be arranged within the amusement park 68. In this subvenue various props (drawing tools, work areas) as well as devices 78 for engaging with the playdate could be provided. A desktop computer 28 coupled to the system 11 could be available within the amusement park 68 so that amusement park employees could engage with the virtual playdate, either to coordinate content and otherwise manage the system, or to involve themselves as participants facilitating the engagement of other participants.

FIG. 3 illustrates a block diagram of an experience agent 100 according to one example embodiment. The experience agent 100 includes an application programming interface (API) 102 and a sentio codec 104. The API 102 is an interface which defines services of all types, low level through user specific interface aspects, within the platform, and enables the different agents to communicate with one another and request services.

The sentio codec 104 is a combination of hardware and/or software which enables encoding of many types of data streams for operations such as transmission and storage, and decoding for operations such as playback and editing. These data streams can include standard data such as video and audio. Additionally, the data can include graphics, sensor data, gesture data, and emotion data. (“Sentio” is Latin roughly corresponding to perception or to perceive with one's senses, hence the nomenclature “sensio codec.”)

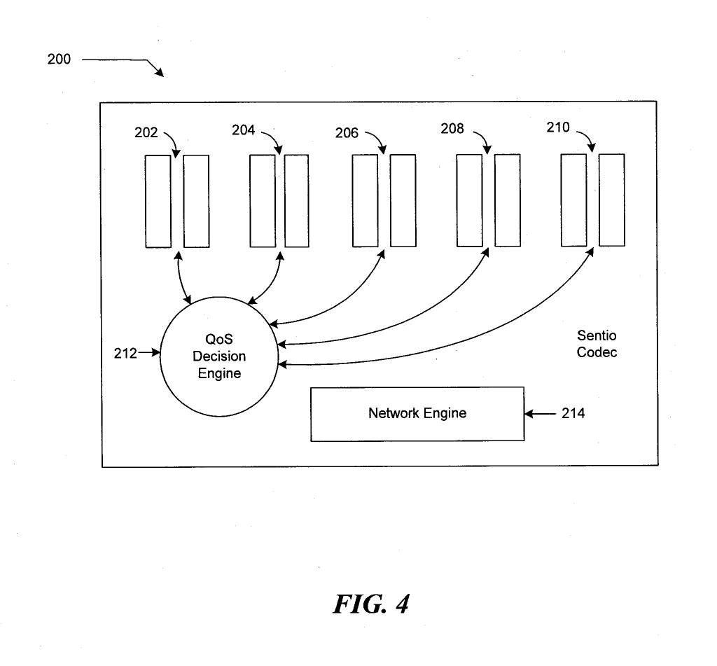

FIG. 4 illustrates a block diagram of a sentio codec 200 according to another example embodiment. The sentio codec 200 includes a plurality of codecs such as video codecs 202, audio codecs 204, graphic language codecs 206, sensor data codecs 208, and emotion codecs 210. The sentio codec 200 further includes a quality of service (QoS) decision engine 212 and a network engine 214.

The codecs, the QoS decision engine 212, and the network engine 214 work together to encode one or more data streams and transmit the encoded data according to a low-latency transfer protocol supporting the various encoded data types. One example of this low-latency protocol is described in more detail in Vonog et al.'s U.S. patent application Ser. No. 12/569,876, filed Sep. 29, 2009, and incorporated herein by reference for all purposes including the low-latency protocol and related features such as the network engine and network stack arrangement. Many of the features and aspects of the present virtual playdate teachings are more readily accomplished when an effective low-latency protocol is utilized across the network.

The sentio codec 200 can be designed to take all aspects of the experience platform into consideration when executing the transfer protocol. The parameters and aspects include available network bandwidth, transmission device characteristics and receiving device characteristics. Additionally, the sentio codec 200 can be implemented to be responsive to commands from an experience composition engine or other outside entity to determine how to prioritize data for transmission. In many applications, because of human response, audio is the most important component of an experience data stream, and thus audio is naturally a priority. However, a specific application may desire to emphasize video or gesture commands, text, or any other aspect.

The sentio codec 200 provides a capability to encode data streams corresponding to many different senses or dimensions of an experience. For example, a device 12 may include a video camera capturing video images and audio from a participant. The user image and audio data may be encoded and transmitted directly or, perhaps after some intermediate processing, via the experience composition engine 48, to the service platform 46 where one or a combination of the service engines can analyze the data stream to make a determination about an emotion of the participant. This emotion can then be encoded by the sentio codec 200 and transmitted to the experience composition engine 48, which in turn can incorporate this into a dimension or layer of the experience. Similarly a participant gesture can be captured as a data stream, e.g. by a motion sensor or a camera on device 12, and then transmitted to the service platform 46, where the gesture can be interpreted, and transmitted to the experience composition engine 48 or directly back to one or more devices 12 for incorporation into a dimension of the experience.

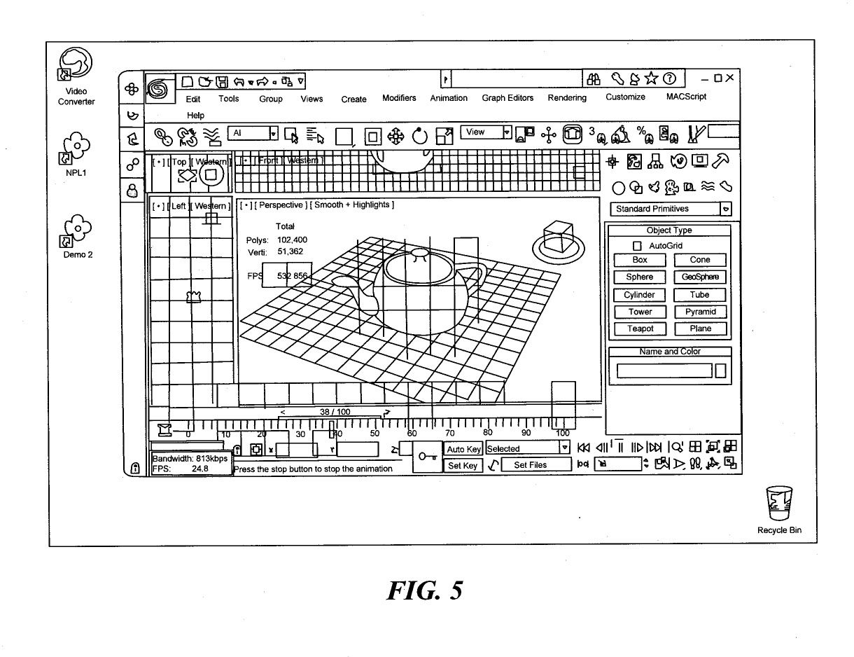

FIG. 5 provides an example experience showing 4 layers. The specific content of these layers may not be particularly relevant to most virtual playdate examples, but this is useful to illustrate how distributed processing and low-latency protocol can facilitate complex experiences. These layers are distributed across various different devices. For example, a first layer is Autodesk 3ds Max instantiated on a suitable layer source, such as on an experience server or a content server. A second layer is an interactive frame around the 3ds Max layer, and in this example is generated on a client device by an experience agent. A third layer is the black box in the bottom-left corner with the text “FPS” and “bandwidth”, and is generated on the client device but pulls data by accessing a service engine available on the service platform. A fourth layer is a red-green-yellow grid which demonstrates an aspect of the low-latency transfer protocol (e.g., different regions being selectively encoded) and is generated and computed on the service platform, and then merged with the 3ds Max layer on the experience server.

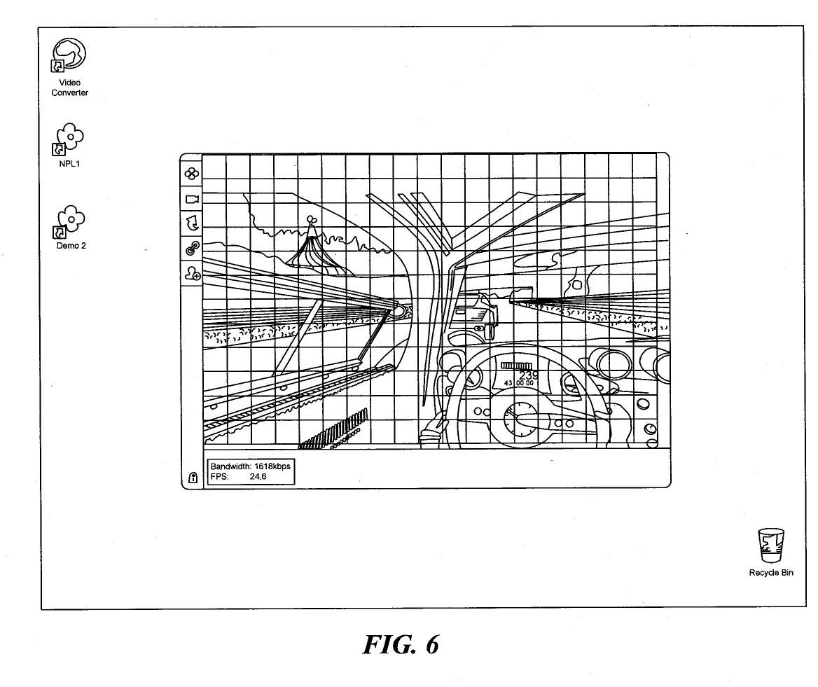

FIG. 6 shows another four layer example, but in this case instead of a 3ds Max base layer, a first layer is generated by piece of code developed by EA and called “Need for Speed.” A second layer is an interactive frame around the Need for Speed layer, and may be generated on a client device by an experience agent, on the service platform, or on the experience platform. A third layer is the black box in the bottom-left corner with the text “FPS” and “bandwidth”, and is generated on the client device but pulls data by accessing a service engine available on the service platform. A fourth layer is a red-green-yellow grid which demonstrates an aspect of the low-latency transfer protocol (e.g., different regions being selectively encoded) and is generated and computed on the service platform, and then merged with the Need for Speed layer on the experience server. It will be appreciated that a game layer can be a very important, but bandwidth consuming part of a virtual playdate. The present system supports a game layer.

FIGS. 1-6 above provide several possible architects supporting virtual playdate experiences through distributed processing and low-latency protocols. As will be appreciated, a variety of virtual playdate experience types or genres can be implemented on the experience platform. One genre is an interactive, multi-participant playdate experience created and initiated by a host participant, the playdate experience including content, social and interactive layers.

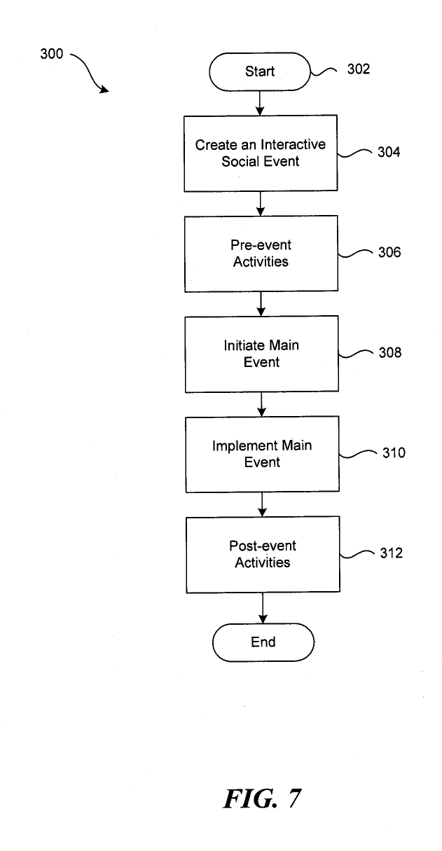

FIG. 7 is a flow chart illustrating certain acts involved in a parent scheduled virtual playdate. Specifically, FIG. 7 shows a method 300 for providing an interactive virtual playdate event experience with layers. The virtual playdate method 300 begins in a step 302. Step 302 could be considered an initialization step bringing us to the point where a parent or host participant may create and initiate an event. In step 302, a variety of initial procedures occur. For example, the platform necessary to support the event is put together. Potential participants may register for the various services and content sources necessary to participant in the eventually designed event. Certain events may only be available to members of a specific organization providing aspects of the virtual playdate.

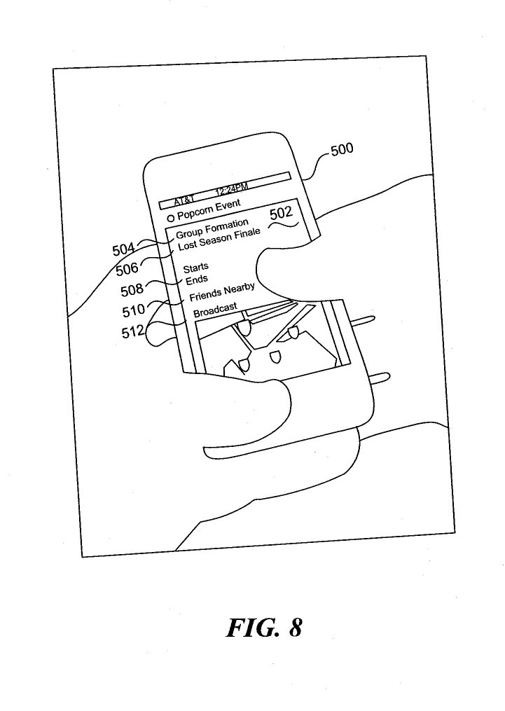

100651 The method 300 continues in a step 304 where a host parent creates the interactive social event, presumably intended for the host parent's child(ren) and friends. In this virtual playdate, a host parent engages with an interface to create the event. FIG. 8 specifically shows a handheld device 500 with an interface 502 providing options for “Group Formation” 504, defined content layer 506, time window 508, Friends Nearby 510, and Broadcast 512. The interface 502 is one suitable interface for the host participant to create the event on a handheld device 500 such as an iPhone.

In certain embodiments, the device utilized by the host parent and the server providing the event creation interface each have an experience agent. Thus the interface can be made up of layers, and the step of creating the virtual playdate can be viewed as one experience. Alternatively, the virtual playdate can be created through an interface where neither device nor server has an experience agent, and/or neither utilizes an experience platform.

The interface and underlying mechanism enabling the host participant to create and initiate the virtual playdate can be provided through a variety of means. For example, the interface can be provided by a content provider to encourage consumers to access the content. The content provider could be a broadcasting company such as NBC, an entertainment company like Disney, etc. The interface could also be provided by an aggregator of content, like Netflix, to promote and facilitate use of its services. Alternatively, the interface could be provided by an experience provider sponsoring an event, or an experience provider that facilitates events in order to monetize such events.

In any event, the step 304 of creating the interactive social event will typically include the host parent identifying children from their child's social group to invite (“group formation”), and programming the dimensions and/or layers of the interactive social event. Programming may mean simply selecting a pre-programmed event with set layers defined by the experience provider, e.g., by a television broadcasting company offering the event.

Typically an important aspect of step 304 will be coordinating schedules between children and their parents to best suit everyone involved. This involves sharing schedules and creating invitations. Perhaps at this point one or more children can already be involved, using the platform to draw and/or create virtual invitations. There may be parental involvement aspects. For example, a child may create and send out virtual invitations to their friends, but simultaneously the system could in the background notify the parents of the invitations, and allow the parents control over response and scheduling. Other parental controls can be implemented. One “nice” aspect of the virtual playdate is the inherent privacy aspect. Non-participants will have no way of learning the timing of the virtual playdate, and will simply not have access. This is true “invite only.”

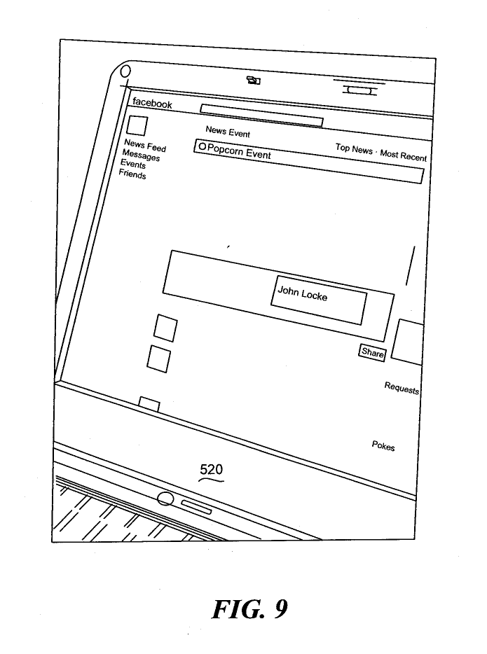

With further reference to FIG. 7, now that the event has been created, the host parent (or a designated child) initiates any pre-event activities in step 306. The “main event” begins with participant children joining a live event and having an interactive virtual playdate experience surrounding any specified content and other layers described. However, social interactive events can begin prior to the main event, e.g., with the act of inviting the various participants, scheduling, etc. For example, FIG. 9 illustrates a portable personal computer 520 where an invited participant receives an invitation or notification of the specific interactive event created by the host parent of FIG. 8.

The pre-event activities may involve a number of additional aspects. These range from sending event reminders and/or teasers, acting to monetize the event, authorizing and verifying participants, distributing ads, providing useful content to participants, implementing pre-event contests, surveys, etc., among participants. For example, the children could be given the option of inviting additional participants from their social networks, and then the host parent would have to approve, new invitations delivered, etc. A survey might be conducted with the children and/or parents for any suitable use. Survey results could control what layers are generated during the event, who can sponsor the event, etc. One can imagine the host parent creating a playdate that has a bunch of different options (base layer could be any of several movies, other layers such as drawing, animation effects, video-chat, etc) which could be selected by the children and/or the parents in advance.

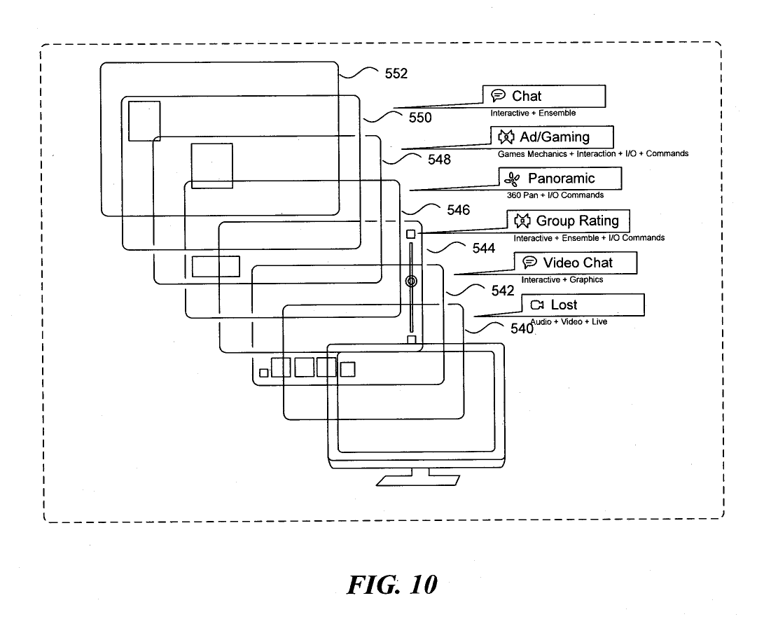

In a step 308, the host parent or a designated child initiates the main event, and in a step 310, the experience provider in real time composes and directs the virtual playdate based on the creation and other factors. Of course, the virtual playdate may also run itself, with the children participants controlling certain aspects and directing the course of action. FIG. 10 illustrates some possible layers of the virtual playdate event. Here a first layer 540 provides live audio and/or video dimensions corresponding to an episode of a television show as the base content layer. A video chat layer 542 provides interactive, graphics and ensemble dimensions. A Group Rating layer 544 provides interactive, ensemble, and i/o commands dimensions. A panoramic layer 546 provides 360 panning and i/o commands dimensions. An ad/gaming layer 548 provides game mechanics, interaction, and i/o commands dimensions. A chat layer 550 provides interactive and ensemble dimensions. A chalk talk layer 552 provides an interactive social drawing tool.

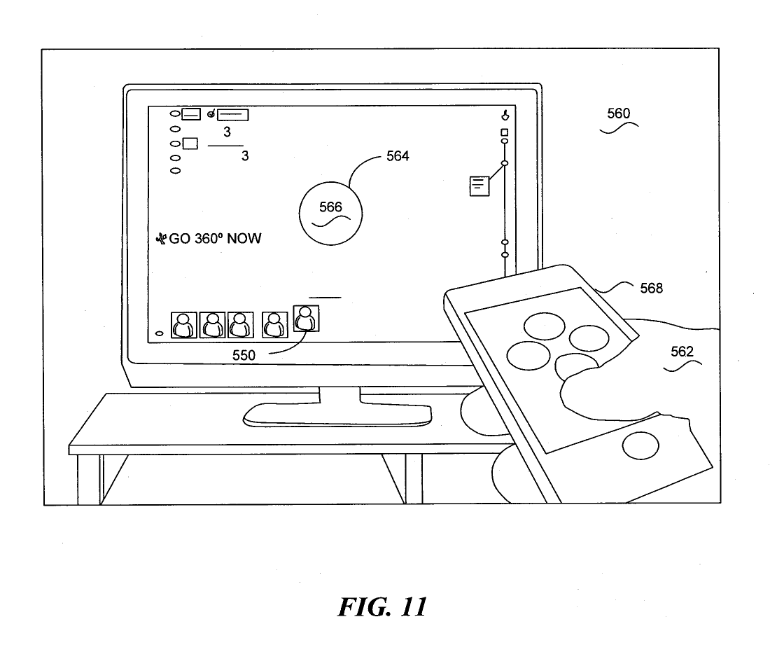

FIGS. 11-14 illustrate one example virtual playdate event as it is happening across several possible different geographic locations including a child's room in a home, a game room in a home, an amusement park, and a subvenue at an amusement park. In each of these locations, different children and/or adult participants are experiencing the virtual playdate event utilizing a variety of different devices. As can be seen, the participants are each utilizing different sets of layers, either through choice, or perhaps as necessitated by the functionality of the available devices.

FIG. 11 illustrates a first child participating in the virtual playdate from a room 560 at a home location. FIG. 11 also shows utilization of the group video ensemble. In the group video ensemble, video streams are received from multiple children and are remixed as a layer on top of the base content layer. The video layers received from the participants can be remixed on a server, or the remixing can be accomplished locally through a peer-to-peer process. For example, if the participants are many and the network capabilities sufficient, the remixing may be better accomplished at a remote server. If the number of participants is small, and/or all participants are local, the video remixing may be better accomplished locally, distributed among the capable devices.

FIG. 11 further provides a layer with “highlighting/outlining” dimensions. For example, the local child participant 562 has drawn a circle 564 around some object 566. The circle 564 could be used to highlight the object 566 and deliver some relevant point to other participants. Drawing the circle 564 could also act as a selection process, perhaps initiating a process whereby a representation of the selected object 566 becomes a virtual object which the child 562 can purchase, store, share, and/or trade with other participants. The circle 564 could be drawn with a device 568 using touch on an iPad or an iPhone, or a mouse, etc. The layer containing the circle 564 and point could be merged in real-time with the base layer so that all participants can view this layer.

With still further reference to FIG. 11 a mobile device such an iPhone can be used to add physicality to the experience similar to Wii's motion-sensing controller. In certain embodiments, virtual playdates are enhanced through gestures and movements sensed by the mobile device that help participants evoke emotion. E.g., an iPhone can be used by a participant to simulate throwing tomatoes on screen. Another example is applause—you can literally clap on your iPhone using a clap gesture. The mobile device typically has some kind of motion-sensing capability such as built-in accelerometers, gyroscopes, or IR-assisted (infrared cameras) motion sensing, video cameras, etc. Microphone and video camera input can be used to enhance the experience. As will be appreciated, there are a variety of gestures suitable for enhancing the virtual playdate. More of these gestures are described in Lemmey et al.'s provisional patent application Ser. No. 61/373,339, filed Aug. 13, 2010, and entitled “Method and System for Device Interaction Through Gestures,” the contents of which are incorporated herein by reference.

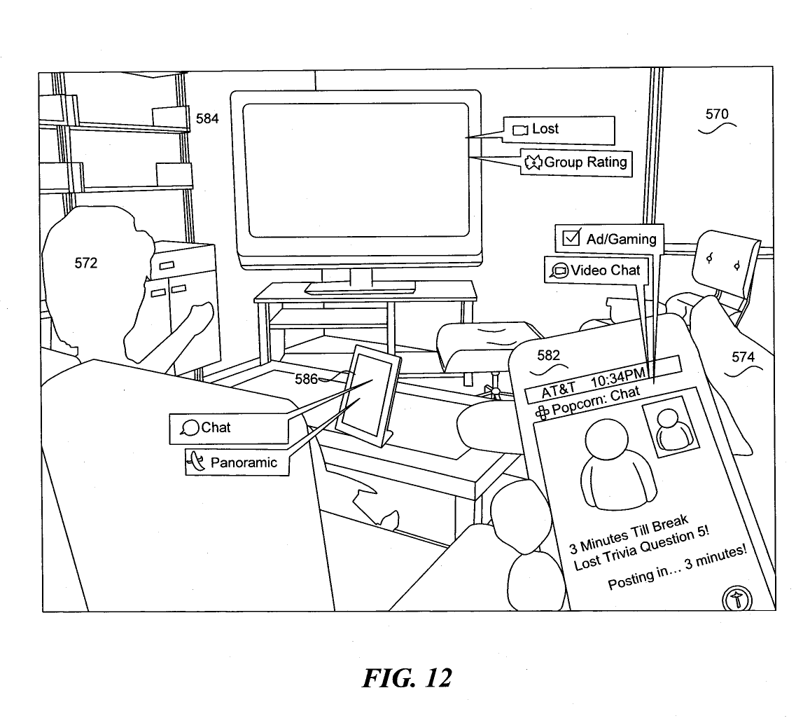

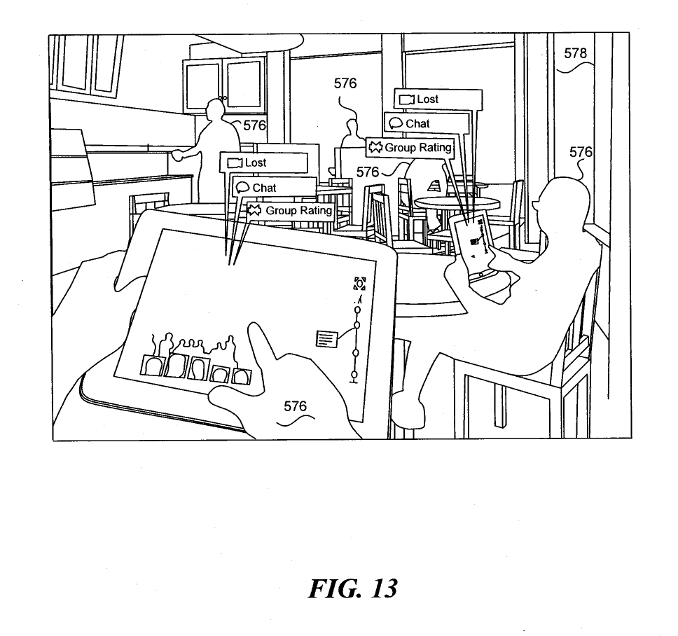

FIG. 12 illustrates two children participants 572 and 574 participating in a virtual playdate while present in a game room 570 at one of the children's homes. FIG. 13 illustrates a plurality of children 576 participating in a virtual playdate while present in a subvenue 578 located at an amusement park 580. In any of these venues, a variety of additional sensors can be utilized to enhance the experience. Video and/or motion sensors could capture children doing activity like dancing, skipping, wrestling (kid stuff!), etc. Identifying these activities could provide indirect indication of emotions, and the level of participant engagement. This information could be utilized to adapt the virtual playdate, or could be conveyed to remote participants. A weather sensor could be useful in an outdoor venue—e.g., if it was raining or particularly cold, a remote child participating would not waste their time trying to connect with another participant at the remote outdoor venue, but could look elsewhere.

In addition to showing two possible venues, FIGS. 12-13 illustrate, among other aspects, which different sets of layers can go to different devices depending upon the participants' desire and the capability of the different devices. FIG. 12 shows a child 574 using a portable device 582 with an ad/gaming layer and a video chat layer. As a display screen 584 is actively presenting the content to the child 574, there is little need to attempt to display the content on the portable device 582. A laptop computer 586 with a chat layer and a panoramic layer is also shown. Further, participants can engage in the experience using multiple devices and sharing at least one device, e.g., the participants associated with the portable device 582 and the laptop computer 586 each have visual access to and share the display 584. In subvenue setting of FIG. 13, each participant may have their own portable device with multiple layers demonstrating that participants can engage in the event experience using a single device such as an iPad remotely (w/o TV or multi-device setup). These portable devices may be available for loan at the subvenue.

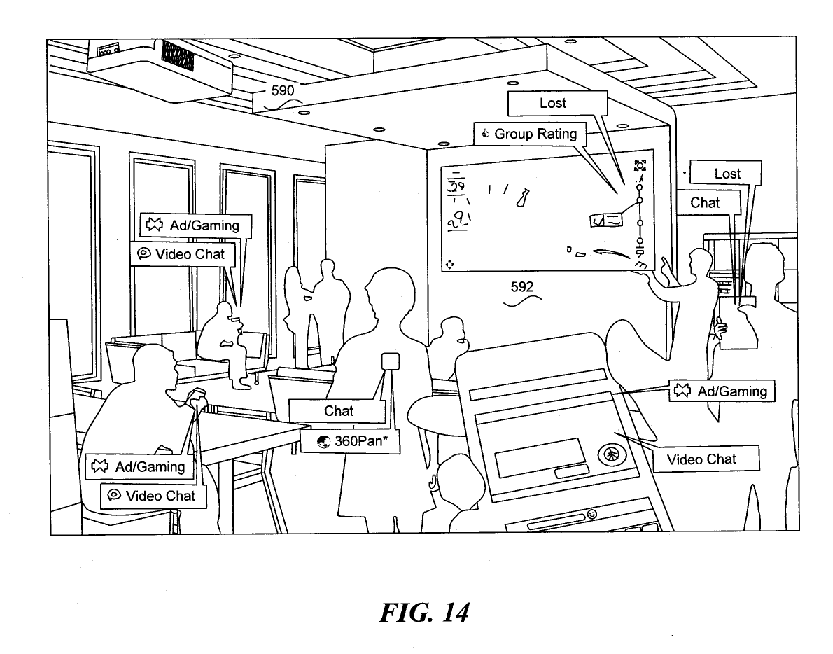

FIG. 14 illustrates a group a group of children interacting locally at an amusement park 590 in an outside area near a large screen display 592, in addition to other children in remote locations such as described above. This demonstrates ensemble activity with multiple roles, e.g., one child could be a quiz director setting up and directing a quiz, and the children are participating in game mechanics specifically within this local group. Some layers are generated in a peer-to-peer fashion locally, not going to the server which serves all participant groups, and in fact these layers may not be remixed and sent to remote groups, but could be experienced only locally by those children present at the amusement park. In turn, layers specific to children not present at the amusement park could be available. Or, the children may be in separate teams, with each team having a unique set of layers to foster collaboration within a team, and enable competition between teams.

The example of FIG. 14 also illustrates how the teachings found herein can provide a virtual playdate experience around a TV show or programming such as live sports. No human resources on the base content provider's side are required to create engaging overlays—they are child generated in real-time. The example highlights the value of layers, ensemble, physicality, group formation, and pre-post event activities.

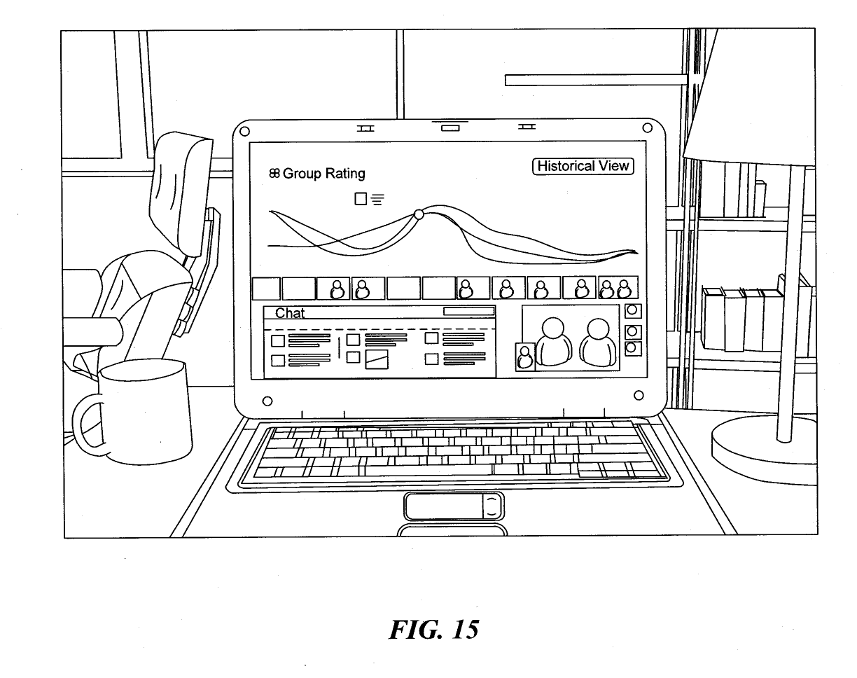

Now that one virtual playdate has been described in some detail, we continue the flow of FIG. 7 where a step 312 implements post-event activities. As will be appreciated, a variety of different post-event activities can be provided. For example, FIG. 15 illustrates an interface provided on a desktop computer for a child to interact with a historical view of the virtual playdate. This may include an interactive review window of the chat layer, and yet another layer could provide an interactive review window of the video chat. Other layers could relate to scoring (if any competition) during the playdate, activity with virtual goods, etc. These post-event activities could be engaged in independently by the child participants, or could involve additional ensemble interactive dimensions.

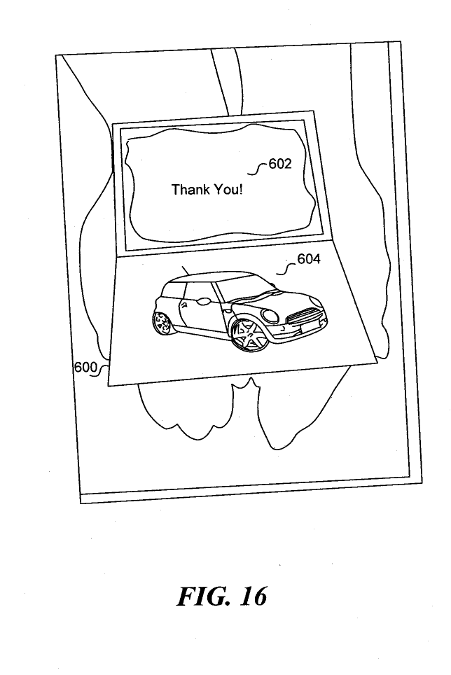

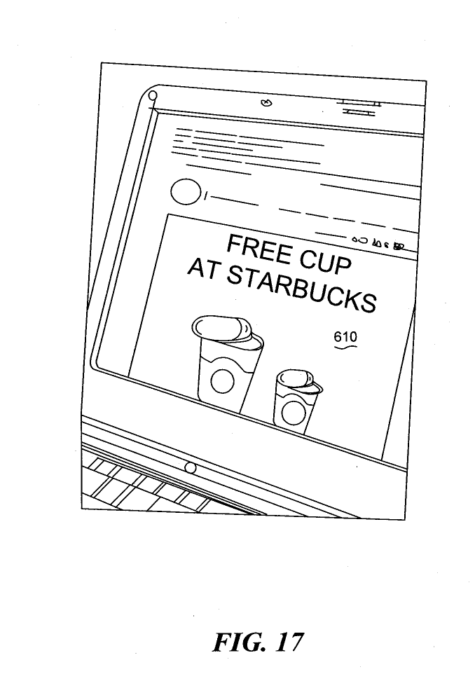

As another example of suitable post-event activity, FIG. 16 illustrates a card 600 created, during or after, by a child participant for delivery to another participant. The card 600 may have default or unique text 602, as well as have an object 602 printed on it. The object 602 could correspond to a virtual object selected by the child participant during the virtual play date. As will be appreciated, a variety of different ad types or marketing campaigns may be served to participants following the event. FIG. 17 illustrates an email coupon 610 delivered to a child participant. The coupon, reward, award, etc. could be age appropriate. The post-event activities could be generated as a function of data mined during the event, or relate to an event sponsor. For example, perhaps during the main event, one participant chatted a message such as “I could use a drink [or coffee] right now.” This might provoke a post-event email with a Starbucks or Jambajuice advertisement. As another example, perhaps an adult participant chats a message like “I love that car!” during a scene where the content layer was showing a “Mini Cooper.” Then a suitable post-event activity might be to invite the adult participants on a test drive of a Mini.

If desired, the virtual playdate can of course be monetized in a variety of ways, such as by a predefined mechanism associated to a specific event, or a mechanism defined by the host parent. For example, there may be a direct charge to one or more participants, or the event may be sponsored by one or more entities. In some embodiments, the host parent directly pays the experience provider during creation or later during initiation of the event. Each participant may be required to pay a fee to participate, and the fee may be age based. In some cases the fee may correspond to the level of service made available, or the level of service accessed by each participant, or the willingness of participants to receive advertisements from sponsors. For example, the event may be sponsored, and the host participant only be charged a fee if too few (or too many) participants are involved. The event might be sponsored by one specific entity, or multiple entities could sponsor various layers and/or dimensions. In some embodiments, the host parent may be able to select which entities act as sponsors, while in other embodiments the sponsors are predefined, and in yet other embodiments certain sponsors may be predefined and others selected. If the participants do not wish to see ads, then the event may be supported directly by fees to one or more of the participants, or the free-riding participants may only have access to a limited selection of layers.

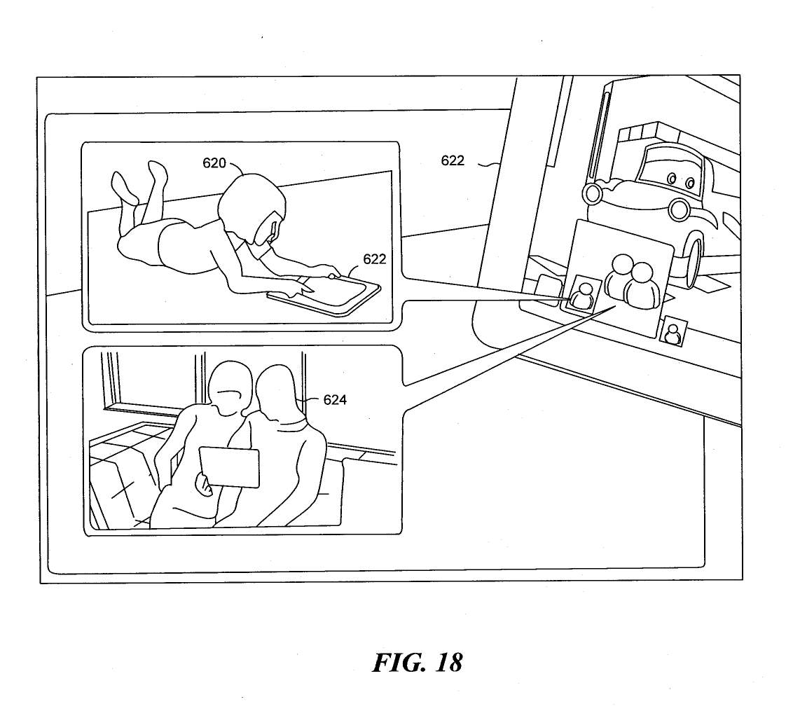

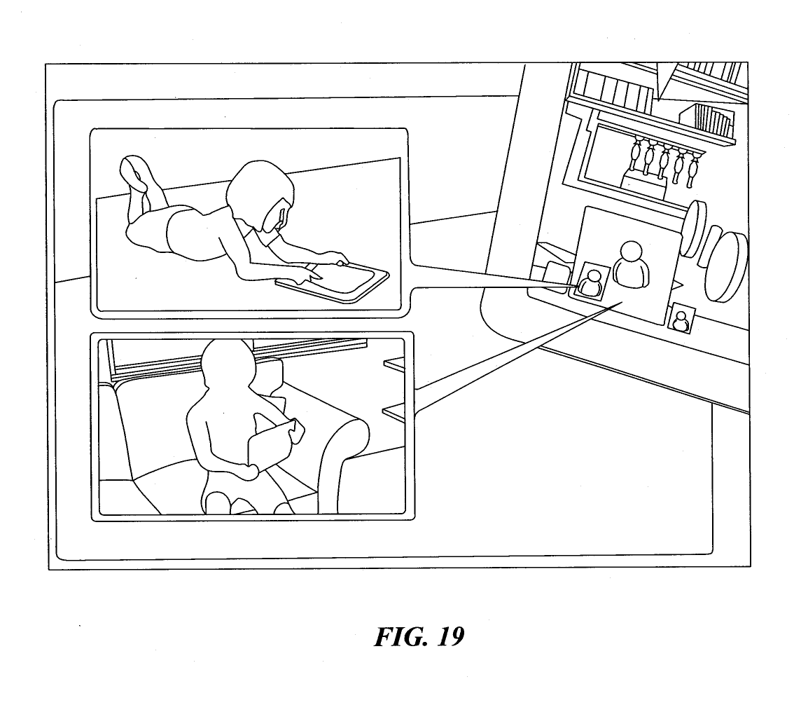

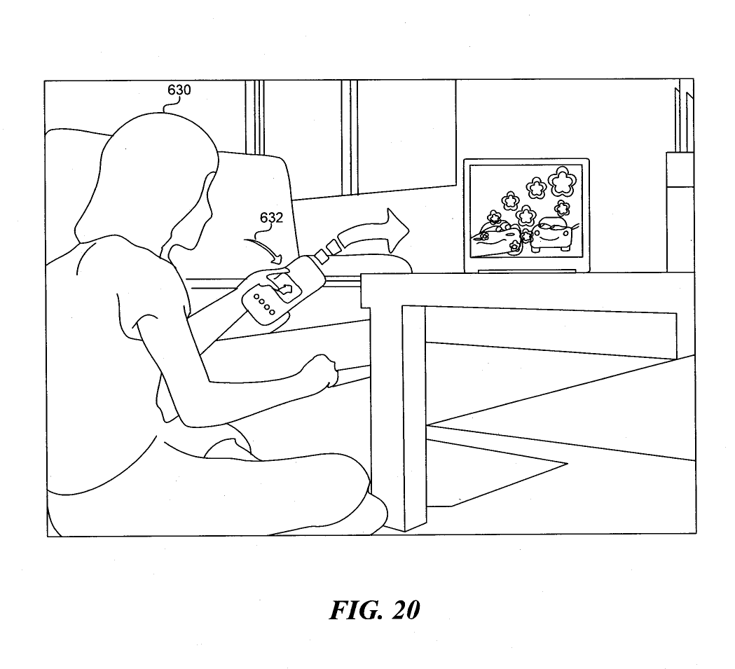

FIGS. 18-20 will now be used to describe certain aspects of a virtual playdate or family experience. FIG. 18 illustrates how an experience can involve a plurality of family members including, here specifically a child 620 and the child's grandparents 622, both having portable devices 624, are watching a video while engaged via a video chat window. FIG. 19 show two children who have set up a virtual playdate, thus eliminating the need for parents to drive their children around. The virtual playdate could include security and/or parental control features. FIG. 20 shows a child 630 working with a gesture 632 that results in animated flowers displaying in a layer of the experience. The flowers could be just fleeting animation, or could end up as virtual goods for use by the child elsewhere. Other child participants may see the animation, depending on a variety of things such as child 630, and the functionality available in the specific playdate.

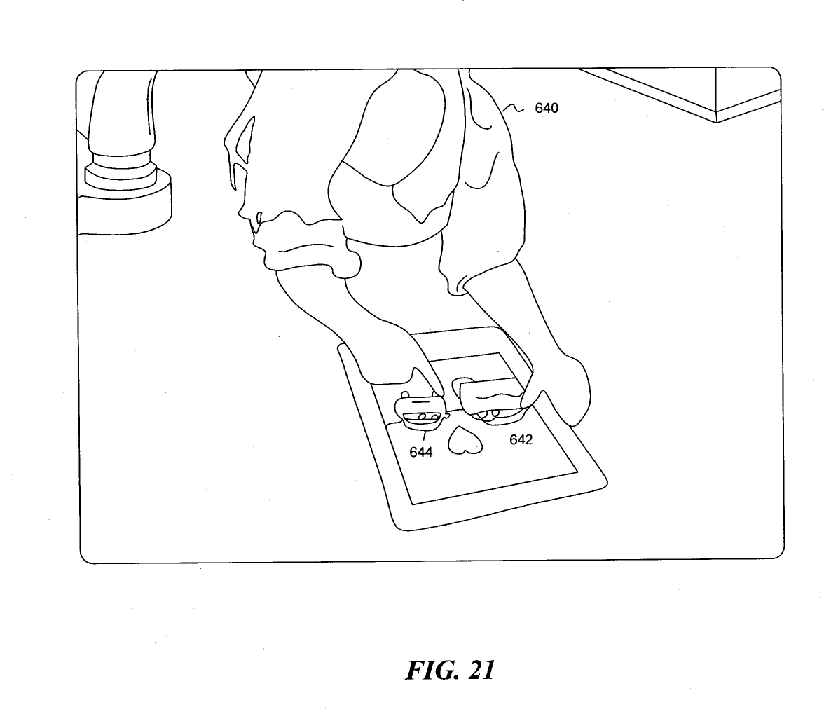

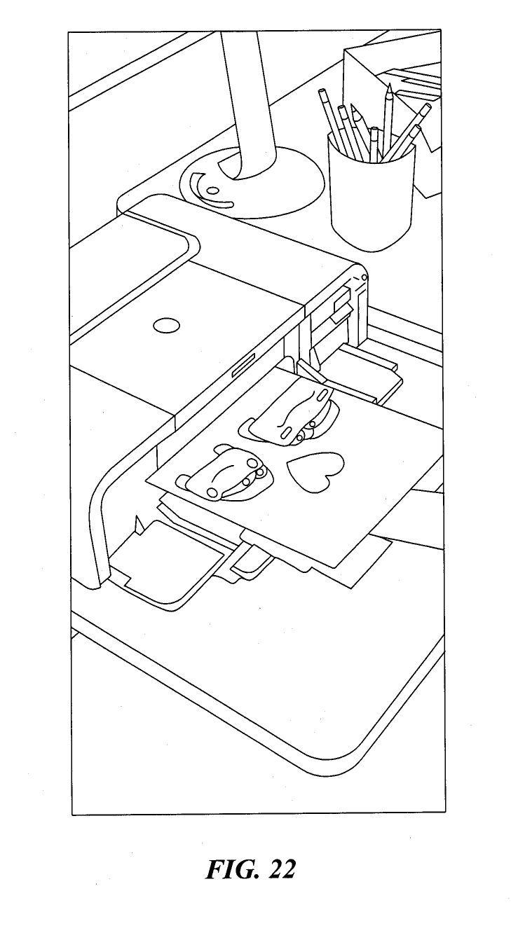

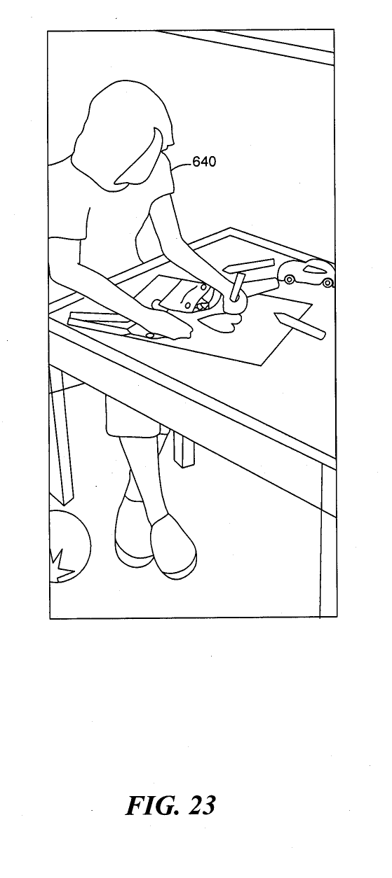

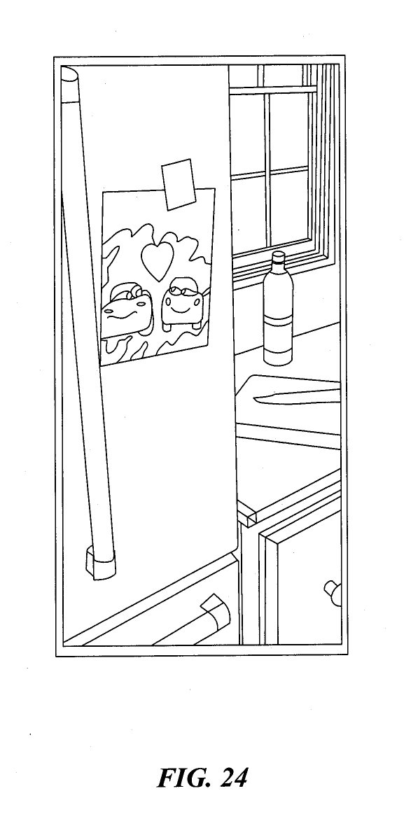

FIGS. 21-24 illustrate a child 640 working with a drawing layer 642 to create a FIG. 644 for printing and image 646 that could include details from multiple layers. Here specifically, the child is using a drawing application layer to outline automobile shapes from an underlying layer, and add a heart shaped sketch to an image. The created image could include both features directly from the content layer, as well as the sketching capture in the drawing layer. FIGS. 22-24 illustrates how one drawing that just has the child sketching may be printed out for use, thus allowing the virtual playdate to expand beyond the virtual realm.

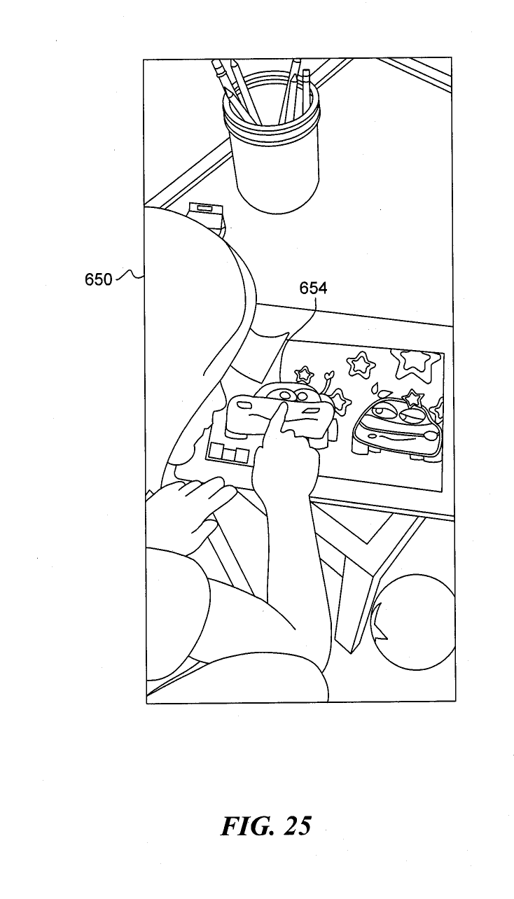

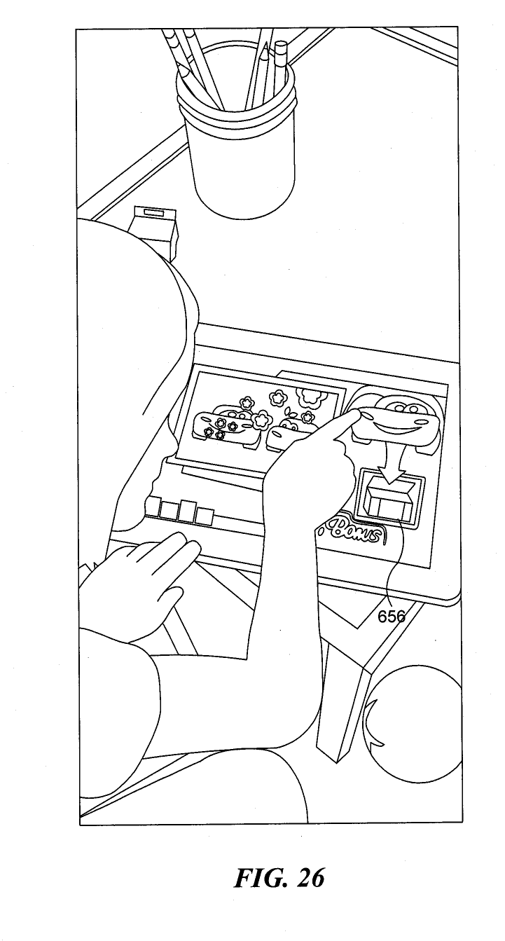

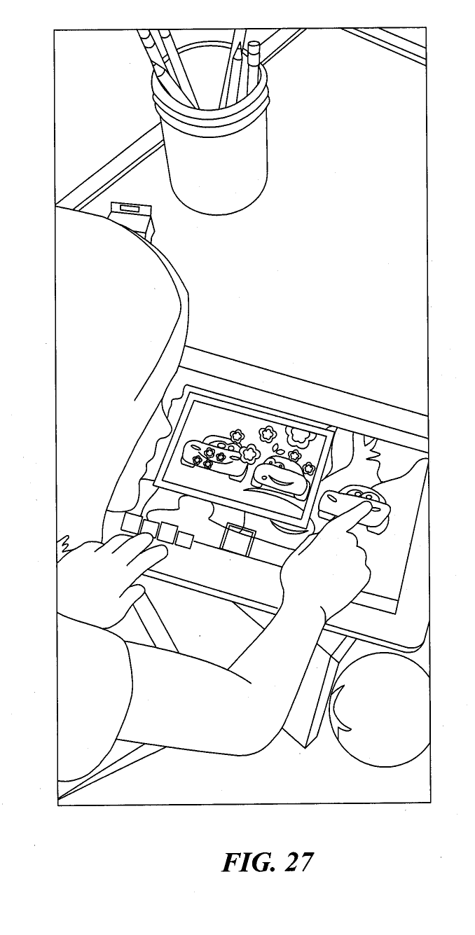

FIGS. 25-27 illustrate another aspect of a virtual playdate. In FIG. 25, a child participant 650 can select an object from a content layer 652, such as selecting a specific car 654, and taking some action. Any variety of options may be provided to the child participant 650 for interacting with selected objects. For example, in FIG. 26, the child participant 650 moves the selected specific car 654 into a storage layer 656. This storage layer 656 could save the specific car 504 as a virtual good, which could be shared and/or traded with other participants. The activity could initiate something like placing a toy version into a virtual shopping cart and providing additional options for purchase. Alternatively, other content identified as related to the specific car could be available, and such content could be provided through any variety of mechanisms. In another embodiment, selecting the specific car 654 simply leaves that object highlighted or emphasized in some manner as the content of the layer 652 progresses. In FIG. 27, the child can retrieve an instance of the selected specific car 654 and port the instance into another layer, such as a drawing layer or a postcard creation layer.

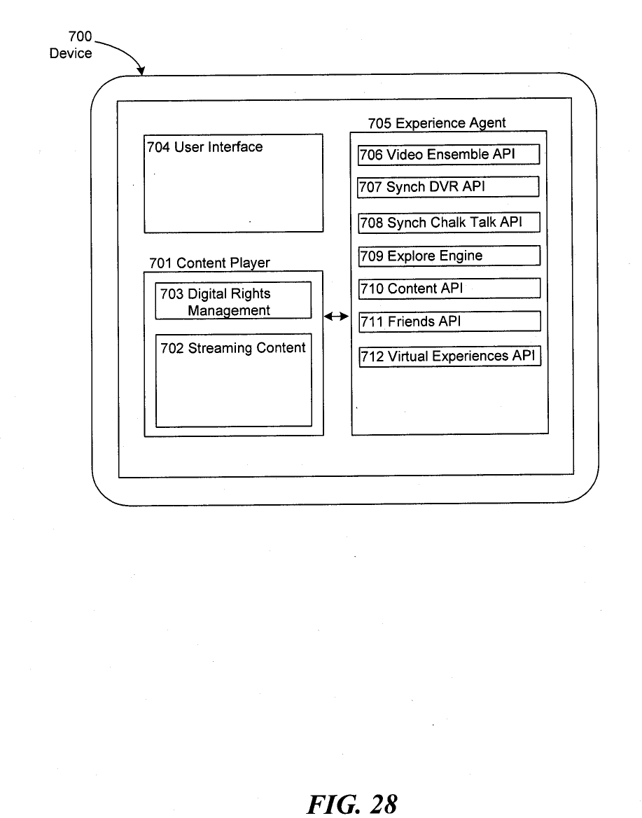

FIG. 28 illustrates a device 700 for presenting and participating multi-dimensional real-time virtual playdates. The device 700 comprises a content player 701, a user interface 704 and an experience agent 705. The content player 701 presents to a user of the device 700 a streaming content 702 received from a content distribution network. The user interface 704 is operative to receive an input from the user of the device 700. The experience agent 705 presents one or more live real-time participant experiences transmitted from one or more real-time participant experience engines typically via a low-latency protocol, on top of or in proximity of the streaming content 702.

In certain embodiments, the experience agent 705 presents the live real-time virtual playdate by sending the experience to the content player 701, so that the content player 701 displays the streaming content 702 and the live real-time participant experience in a multi-layer format. In some embodiments, the experience agent is operative to overlap the live real-time participant experiences on the streaming content so that the device presents multi-layer real-time participant experiences.

In some embodiments, the low-latency protocol to transmit the real-time participant experience comprises steps of dividing the real-time participant experience into a plurality of regions, wherein the real-time participant experience includes full-motion video, wherein the full-motion video is enclosed within one of the plurality of regions; converting each portion of the real-time participant experience associated with each region into at least one of picture codec data and pass-through data; and smoothing a border area between the plurality of regions.

In other embodiments, the experience agent 705 is operative to receive and combine a plurality of real-time participant experiences into a single live stream.

In some embodiments, the experience agent 705 may communicate with one or more non-real-time services. The experience agent 705 may include some APIs to communicate with the non-real-time services. For example, in some embodiment, the experience agent 705 may include content API 710 to receive a streaming content search information from a non-real-time service. In some other embodiments, the experience agent 705 may include friends API 711 to receive friends' information from a non-real-time service.

In some embodiments, the experience agent 705 may include some APIs to receive live real-time participant experiences from real-time experience engines. For example, the experience agent may have a video ensemble API 706 to receive a video ensemble real-time participant experience from a video ensemble real-time experience engine. The experience agent 705 may include a synch DVR API 707 to receive a synch DVR real-time participant experience from a synch DVR experience engine. The experience agent 705 may include a synch Chalktalk API 708 to receive a Chalktalk real-time participant experience from a Chalktalk experience engine. The experience agent 705 may include a virtual experience API 712 to receive a real-time participant virtual experience from a real-time virtual experience engine. The experience agent 705 may also include an explore engine.

The streaming content 702 may a live or on-demand streaming content received from the content distribution network. The streaming content 702 may be received via a wireless network. The streaming content 702 may be controlled by a digital rights management (DRM). In some embodiments, the experience agent 705 may communicate with one or more non-real-time services via a human-readable data interchange format such as HTTP JSON.

As will be appreciated, the experience agent 705 often requires certain base services to support a wide variety of layers. These fundamental services may include the sentio codec, device presence and discovery services, stream routing, i/o capture and encode, layer recombination services, and protocol services. In any event, the experience agent 705 will be implemented in a manner suitable to handle the desired application.

Multiple devices 700 may receive live real-time participant experiences using their own experience agent. All of the live real-time participant experiences presented by the devices may be received from a particular ensemble of a real-time experience engine via a low-latency protocol.

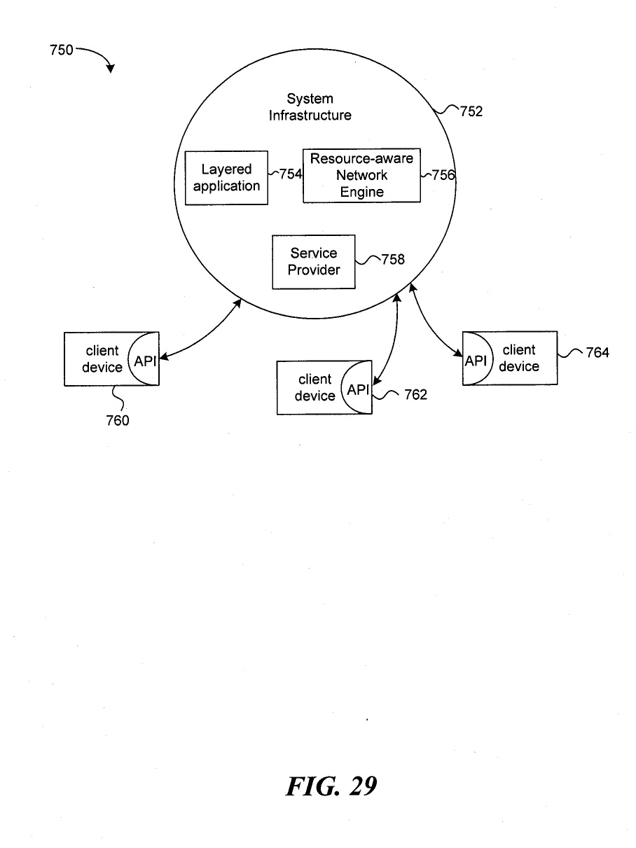

FIG. 29 illustrates a block diagram of a system 750 according to one embodiment. The system 750 is well suited for providing distributed execution or rendering of various layers associated with a virtual playdate involving layers. A system infrastructure 752 provides the framework within which a layered virtual playdate 754 can be implemented. A layered virtual playdate can be considered a composite of layers. Example layers could be video, audio, graphics, or data streams associate with other senses or operations. Each layer requires some computational action for creation.

With further reference to FIG. 29, the system infrastructure 752 further includes a resource-aware network engine 756 and one or more service providers 758. The system 750 includes a plurality of client devices 760, 762, and 764. The illustrated devices all expose an API defining the hardware and/or functionality available to the system infrastructure 752. In an initialization process or through any suitable mechanism, each client device and any service providers register with the system infrastructure 756 making known the available functionality. During execution of the layered application 754, the resource-aware network engine 756 can assign the computational task associated with a layer (e.g., execution or rendering) to a client device or service provider capable of performing the computational task.

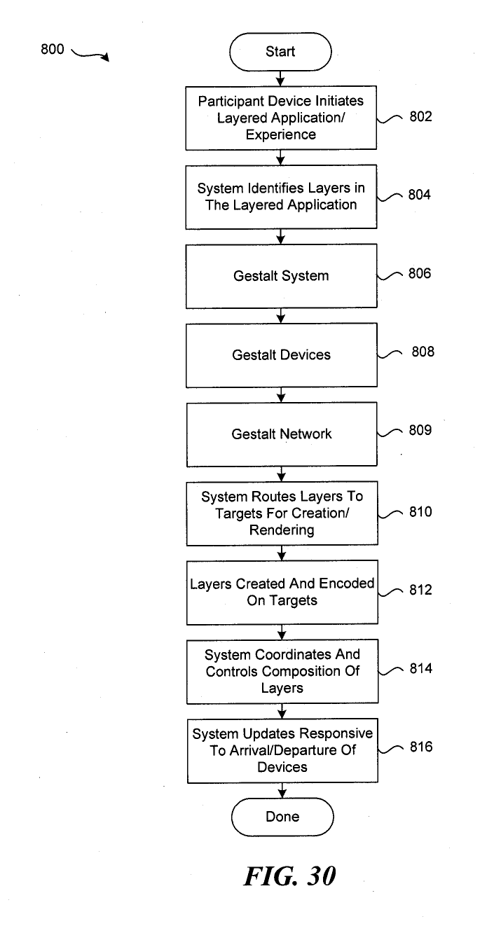

FIG. 30 is a flow chart of a method 800 for distributed creation of a layered application such as a layered virtual playdate. In a step 802, the layered application or experience is initiated. The initiation may take place at a participant device, and in some embodiments a basic layer is already instantiated or immediately available for creation on the participant device. For example, a graphical layer with an initiate button may be available on the device, or a graphical user interface layer may immediately be launched on the participant device, while another layer or a portion of the original layer may invite and include other participant devices.

In a step 804, the system identifies and/or defines the layers required for implementation of the layered application initiated in step 802. The layered application may have a fixed number of layers, or the number of layers may evolve during creation of the layered application. Accordingly, step 804 may include monitoring to continually update for layer evolution.

In some embodiments, the layers of the layered application are defined by regions. For example, the experience may contain one motion-intensive region displaying a video clip and another motion-intensive region displaying a flash video. The motion in another region of the layered application may be less intensive. In this case, the layers can be identified and separated by the multiple regions with different levels of motion intensities. One of the layers may include full-motion video enclosed within one of the regions.

If necessary step 806 gestalts the system. The “gestalt” operation determines characteristics of the entity it is operating on. In this case, to gestalt the system could include identifying available servers, and their hardware functionality and operating system. A step 808 gestalts the participant devices, identifying features such as operating system, hardware capability, API, etc. A step 609 gestalts the network, identifying characteristics such as instantaneous and average bandwidth, jitter, and latency. Of course, the gestalt steps may be done once at the beginning of operation, or may be periodically/continuously performed and the results taken into consideration during distribution of the layers for application creation.

In a step 810, the system routes and distributes the various layers for creation at target devices. The target devices may be any electronic devices contain processing units such as CPUs and/or GPUs. For example, Some of the target devices may be servers in a cloud computing infrastructure. The CPUs or GPUs of the servers may be highly specialized processing units for computing intensive tasks. Some of the target devices may be personal electronic devices from clients, participants or users. The personal electronic devices may have relatively thin computing power. But the CPUs and/or GPUs may be sufficient enough to handle certain processing tasks so that some light-weight tasks can be routed to these devices. For example, GPU intensive layers may be routed to a server with significant amount of GPU computing power provided by one or many advanced many core GPUs, while layers which require little processing power may be routed to suitable participant devices. For example, a layer having full-motion video enclosed in a region may be routed to a server with significant GPU power. A layer having less motion may be routed to a thin server, or even directly to a user device that has enough processing power on the CPU or GPU to process the layer. Additionally, the system can take into consideration many factors include device, network, and system gestalt. It is even possible that an application or a participant may be able to have control over where a layer is created. In a step 812, the distributed layers are created on the target devices, the result being encoded (e.g., via a sentio codec) and available as a data stream. In a step 814, the system the coordinates and controls composition of the encoded layers, determining where to merge and coordinating application delivery. In a step 816, the system monitors for new devices and for departure of active devices, appropriately altering layer routing as necessary and desirable.

As will be appreciated, a variety of content can be provided through layers. Certain layers can provide interactive content, such as a game layer with a game engine allowing the participants to explore a virtual world. Another interactive layer might correspond to a virtual 3D model associated with an animated movie like Cars® or Tron®.

In one virtual playdate, the children could use their devices to act as “blocks” in the virtual world, and work together from remote locations to build structures in a virtual layer. Virtual hide and seek games could be facilitated. Treasure hunting, e.g., a child in an amusement park could be searching for items and could be assisted by remote participants.

A variety of different types of virtual playdates are considered. Virtual birthday parties, overnight stayovers, homework studying sessions, etc. Each of these possibilities have specific features enabled within the paradigm of the present invention.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

1. A method for rendering a layered virtual playdate for one or more children on a group of servers and participant devices, the method comprising:
creating a schedule, participant list including the one or more children, and one or more participant experiences for the layered virtual playdate;
initiating the one or more participant experiences associated with the layered virtual playdate;
defining layers required for implementation of the layered virtual playdate, each of the layers comprising one or more of the participant experiences;
routing each of the layers to one of the plurality of the servers and the participant devices for rendering;
rendering and encoding each of the layers on one of the plurality of the servers and the participant devices into data streams; and
coordinating and controlling the combination of the data streams into the layered virtual playdate.

2. The method of claim 1, further comprising:
performing a survey among the participant list; and
using results from the survey to determine, select, and/or design at least one of the participant experiences.

3. The method of claim 1, wherein creating the schedule includes:
setting a start time for a main event of the layered virtual playdate;
inviting the one or more children from the participant list; and
coordinating with one or more adults responsible for each of the one or more children to confirm and/or receive approval for participation of each of the one or more children.

4. The method of claim 1, wherein the virtual playdate includes a pre-event set of activities, a main event set of activities, and a post-event set of activities, manifested at least in part by associated participant experiences.

5. The method of claim 4, wherein the pre-event set of activities includes a child creating invitations for facilitating scheduling, sending event reminders after the initial transmittal of invitations, and taking a survey.

6. The method of claim 4, wherein the main event includes a base content layer including one or more of a television episode, a movie, a live broadcast event.

7. The method of claim 1, wherein at least one layer is a gesture responsive layer, further comprising:
at a specific device, monitoring sensor data input;
determining whether a child using the specific device intended a predefined gesture;
determining the predefined gesture; and
performing any executable instructions associated with recognizing the predefined gesture at the specific device.

8. The method of claim 7, wherein the recognized predefined gesture corresponds to a request for an animation to occur on a specific layer, further comprising providing the animation on the specific layer.

9. The method of claim 1, wherein at least one layer is an interactive social drawing layer, where participants can draw on the interactive social layer and view other participants drawing.

10. The method of claim 9, wherein the interactive social layer allows participants to trace objects present in a content layer.

11. The method of claim 10 further comprising:
receiving a participant's trace of an object present in the content layer;
storing the participants trace in a drawing file; and
allowing printing of the drawing file.

12. The method of claim 11, wherein the drawing file includes image information from the content layer in addition to the tracing.

13. The method of claim 10 further comprising
receiving a participant's trace of an object present in the content layer;
identifying a virtual object corresponding to the trace;
allowing the participant to act on the virtual object, including store, share trade, and/or purchase the virtual object.

14. The method of claim 10 further comprising
receiving a participant's trace of an object present in the content layer;
identifying an object corresponding to the trace;
subsequently highlighting the object or otherwise drawing attention to the object in response to the identification.

15. The method of claim 1, further comprising a step of:
dividing one or more participant experiences into a plurality of regions, wherein at least one of the layers includes full-motion video enclosed within one of the plurality of regions.

16. The method of claim 15, wherein the defining step further comprises defining layers required for implementation of the layered participant experience based on the regions enclosing full-motion video, each of the layers comprising one or more of the participant experiences.

17. The method of claim 1, wherein the initiating step further comprises:
initiating one or more participant experiences on at least one of the participant devices.

18. The method of claim 1, wherein the servers and participant devices are inter-connected by a network, further comprising:
determining hardware and software functionalities of each of the servers and each of the participant devices;
determining and monitoring the bandwidth, jitter, and latency information of the network; and
deciding a routing strategy distributing the layers to the plurality of servers or participant devices based on hardware and software functionalities of the servers and participant devices, and on the bandwidth, jitter and latency information of the network.

19. A distributed processing system for implementing a virtual playdate, the distributed processing system comprising:
a plurality of devices, a multiplicity of the plurality of devices each including at least one processing unit, the plurality of devices inter-connected via a network, the multiplicity of devices numerically equal to or fewer than the plurality, at least one of the plurality of devices being a large screen display disposed at an amusement park;
a host interface receiving instructions for implementing a virtual playdate, the virtual playdate distributed geographically such that the plurality of devices includes devices are disposed at two or more geographic locations, and the virtual playdate comprising processing tasks distributed across the plurality of devices; and
a distribution agent operable to distribute the processing tasks across the plurality of device as necessary to accomplish the virtual play date.

20. A computer implemented method for providing a virtual playdate, the computer implemented method comprising:
providing a graphical user interface (GUI) for creation of a virtual playdate;
receiving, via the GUI, a request from a host participant to begin creation of a virtual playdate;
receiving, via the GUI, scheduling information from the host participant regarding the virtual playdate;
receiving, via the GUI, an invite list from the host participant for the virtual playdate, the invite list including a plurality of children;
receiving, via the GUI, content information from the host participant for the virtual playdate;
receiving, via the GUI, activity information from the host participant for the virtual playdate;
preparing an initial version of the virtual playdate based on the request, the scheduling information, the invite list, and the content information;
sending electronic invitations, directly or indirectly, to each of the plurality of children, the electronic invitations including information about the initial version of the virtual playdate;
coordinating schedules and invitation acceptances among the plurality of children;
defining the virtual playdate including pre-event, main event, and post-event, as well as defining a plurality of venues to play a part in the virtual playdate;
performing any pre-event activities associated with the virtual playdate;
receiving a request from a designated child to initiate the virtual playdate;
providing the main event involving each child having a device for interfacing with the virtual playdate; and
performing any post-event activities.
